(19) United States
(12) Patent Application Publication
(10) Pub. No.: US 2003/0214230 A1
(43) Pub. Date: Nov. 20, 2003

(54) Dark layer for an electroluminescent device

(76) Inventors: Richard P. Wood, Delhi (CA); Peter G. Hofstra, Guelph (CA); David J. Johnson, Toronto (CA); Alexey N. Krasnov, Brampton (CA)

Correspondence Address: KATTEN MUCHIN ZAVIS ROSENMAN, PATENT ADMINISTRATOR, Suite 1600, 525 West Monroe Street, Chicago, IL, 60661-3693, US

(21) Appl. No.: 10/383,560

(22) Filed: Mar. 10, 2003

Related U.S. Application Data
(60) Provisional application No. 60/377,208, filed on May 3, 2002.

(51) Int. Cl. H01J 1/62

(52) U.S. Cl. 313/506

(57) ABSTRACT

The present invention provides an electroluminescent device having a dark layer for reducing at least a portion of ambient light incident on the display. In one bottom emitting device embodiment, the dark layer is placed between the emitting layer and a reflective rear cathode. The dark layer comprises a partially reflective layer, an absorptive-transmissive layer, and a reflective layer.

### PRIORITY CLAIM

This application claims priority from U.S. Provisional Patent Application No. 60/377,208 filed May 5, 2002, the contents of which are incorporated herein by reference.

### FIELD OF THE INVENTION

The present invention relates to high contrast electroluminescent devices and more specifically relates to high contrast electroluminescent devices with substantially uniform reflection response of reflected ambient light over the spectrum of visible light and with low heat dissipation.

### BACKGROUND OF THE INVENTION

Display devices have become an important part of human life during the past few decades. Electroluminescent display devices (ELDs) are well known and are generally composed of several layers of different materials. They fall into two main categories, namely, Inorganic Electroluminescent Devices, often referred to as TFEL devices (TFEL) and Organic Electroluminescent Devices (OLED). TFELs are typically made from inorganic materials, and OLEDs are made from organic materials.

These layers essentially consist of a transparent front-electrode layer, an electroluminescent layer and a reflecting back-electrode layer. They optionally consist of additional layers for current regulation and other functions according to whether he device being constructed is based on TFEL or OLED. When a voltage is applied across the electrodes, the electroluminescent layer becomes active, converting some portion of the electrical energy passing therethrough into light. This light is then emitted out through the front-electrode, which is transparent to the emitted light, where it is visible to a user of the device.

Electroluminescent devices have been particularly useful as computer displays and are generally recognized as high-quality displays for computers and other electronic devices used in demanding applications such as military, avionics and aerospace where features such as high reliability, low weight, and low power consumption are important. Electroluminescent displays are also gaining recognition for their qualities in automotive, personal computer and other consumer industries, as they can offer certain benefits over other displays such as cathode-ray tubes (“CRT”) and liquid crystal displays (“LCD”).

However, ambient light poses an undesirable effect on all displays, including electroluminescent displays. The reflection of ambient light by the display device screen can cause low picture contrast, thus reducing the picture quality. Improvements to the contrast ratio of an electroluminescent device are generally desirable and particularly important in avionics and military applications where poor contrast and glare can have serious consequences.

U.S. Pat. No. 5,049,780 to Dobrowolski teaches a device having such low reflectance in electroluminescent devices, achieved through the use of destructive interference. Dobrowolski includes specific teachings directed to voltage-driven inorganic electroluminescent devices, where the electroluminescent layer is formed of an inorganic material, and which typically require one or more additional transparent dielectric layers to reduce electrical-breakdown of the inorganic electroluminescent layer. U.S. Pat. No. 6,411,019 to Hofstra teaches an OLED device having improved contrast, which is also achieved through the use of destructive interference. However, when making certain embodiments in Dobrowolski and Hofstra, exacting manufacturing processes can be required to achieve desired results, which can be unsuitable for certain current high volume and low costing requirements for some manufacturing environments.

WO 00/35028 to Berger et al. and “An organic electroluminescent dot-matrix display using carbon layer” Synthetic Metals, May 1997, pages 73-75, by Gyoutoku et al. teach electroluminescent displays that attempt to reduce unwanted ambient light reflections using graphite and carbon layers, respectively. Since graphite and carbon are primarily light absorbing materials, these display devices can have the undesirable property of over-heating, and overall not provide desired levels of ambient light reflection. Another disadvantage of using graphite and carbon is that these materials tend to form films that are not mechanically sound; they have a tendency to rub off. Further, the thickness of these layers that can be required to achieve desired levels of ambient light reduction can be undesirable when implemented in a manufacturing environment.

U.S. Pat. No. 6,429,451 to Hung teaches an OLED device having reduced ambient light reflection. The OLED structure includes a bi-layer interfacial structure and a reflection-reduction layer formed of an n-type semi-conductor having a work function greater than 4.0 eV. The reflection-reduction layer recited therein is typically an absorbing layer of ZnO₁₋ₓ, which can be difficult to deposit consistently on a cost-effective basis in a high-volume manufacturing environment. Furthermore, Hung lacks guidance in providing how to control the various layers recited therein to provide desired levels of ambient light reduction. In addition, Hung does not provide guidance how to influence reflections of ambient light off of the bi-layer structure—i.e. ambient light entering the device that never has an opportunity to reach the reflection-reduction layer.

### SUMMARY OF THE INVENTION

It is therefore an object of the present invention to provide a novel organic electroluminescent device that obviates or mitigates at least one of the above-identified disadvantages of the prior art.

In an aspect of the invention there is provided an electroluminescent device for displaying an image to a viewer in front of the device, comprising: a front transparent anode layer and a rear reflecting cathode layer; at least one organic electroluminescent layer disposed between the anode layer and the cathode layer. The device further comprises at least one dark layer disposed between the electroluminescent layer and the cathode, the dark layer being comprised of a partially reflective layer, an absorptive-transmissive layer, and reflective layer.

In a particular implementation of the first aspect, the device further comprises a first buffer layer and a hole transport layer disposed between the anode and the electroluminescent layer and a second buffer layer disposed between the electroluminescent layer and the cathode layer.

### BRIEF DESCRIPTION OF THE DRAWINGS

The present invention will now be described, by way of example only, with reference to the embodiments shown in the attached Figures in which:

FIG. 1 is a schematic diagram of a cross-section of a bottom emitting electroluminescent device in accordance with the first embodiment of the invention; and,

FIG. 1a is a schematic diagram of a cross-section of a top emitting electroluminescent device in accordance with the second embodiment of the invention.

### DETAILED DESCRIPTION OF THE INVENTION

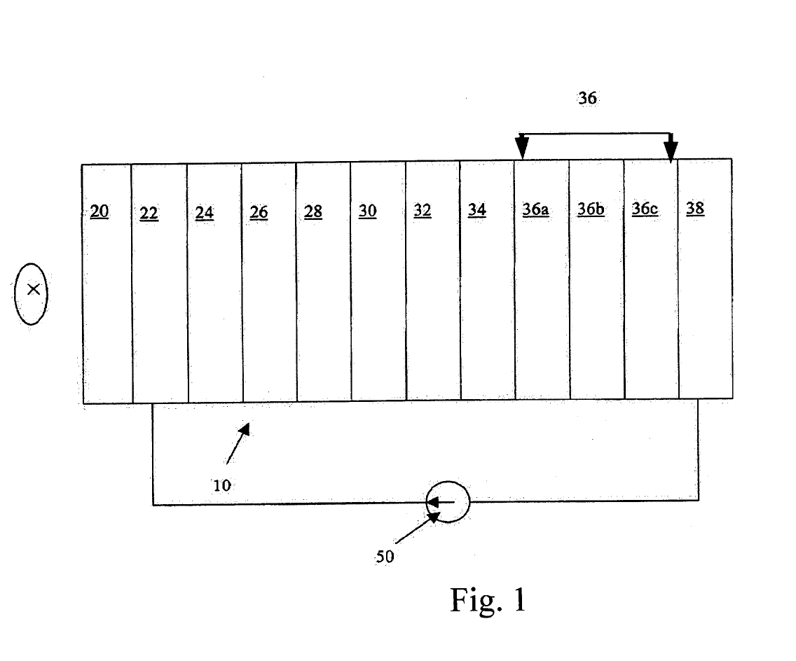

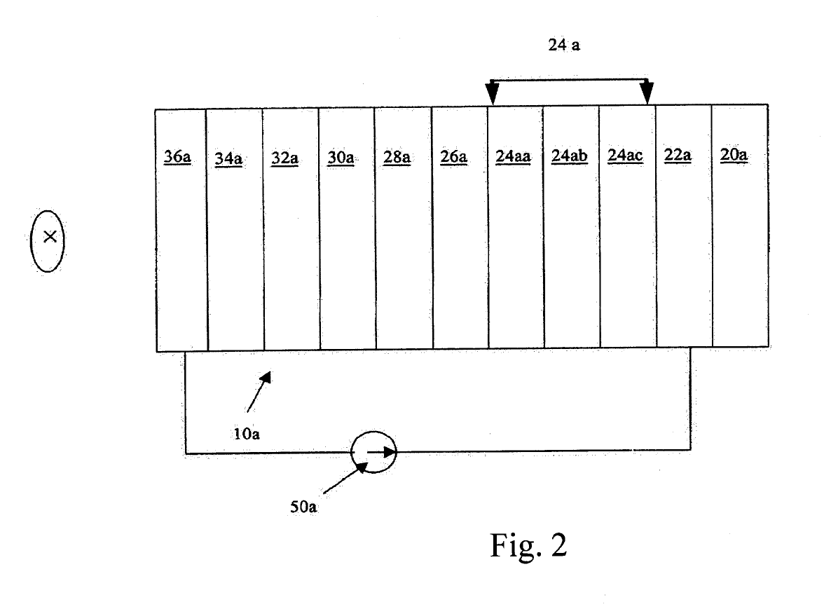

A bottom emitting electroluminescent device in accordance with the first embodiment of the invention is indicated generally at 10 in FIG. 1. Device 10 comprises a substrate 20 facing a viewer X, an electroluminescent transmitting anode 22, a first buffer layer 24, a hole transport layer 26, an electroluminescent layer 28, an electron transport layer 30, a second buffer layer 32, a third buffer layer 34, a dark layer 36 composed of three layers 36a, 36b and 36c, and a reflecting cathode layer 38 disposed as shown in FIG. 1. Device 10 is connected to a current source 50 via anode 22 and cathode 38 in order to drive a constant current through device 10.

Substrate 20 is glass, plastic or other transparent material of suitable thickness for depositing the layers 22-38 using vacuum deposition, spin-coating or other means.

Electroluminescent transmitting anode 22 is any conducting material which is transparent to at least a portion of emitted electroluminescent light, such as indium tin oxide (ITO) or zinc oxide (ZnO). In the present embodiment, anode 22 is a layer of ITO having a thickness of about twelve-hundred angstroms (1200 Å). Other suitable materials and appropriate thicknesses can be determined by those skilled in the art.

First buffer layer 24 is made of Cupric Phthalocynine (CuPc) having a thickness of about two hundred and fifty angstroms (250 Å). Other suitable materials and appropriate thicknesses can be determined by those skilled in the art. The function of this layer is to regulate the hole transportation through the device.

Hole transport layer 26 is made of N,N′-Di(naphthalen-1-yl)N,N′diphenyl-benzidine (NPB; also known as naphthalene diphenyl benzidine), having a thickness of about four hundred and fifty angstroms (450 Å). Other suitable materials and appropriate thicknesses can be determined by those skilled in the art. The function of this layer is to facilitate hole transportation through the device.

Electroluminescent layer 28 and electron transport layer 30 is typically deposited as a single layer of an organic electroluminescent material such as Tris-(8-hydroxyquinoline) aluminum) (Alq3) having an appropriate thickness. In the present embodiment layer 28 and layer 30 are Alq3 having a combined thickness of about six hundred angstroms (600 Å) although those of skilled in the art will be able to determine other appropriate thicknesses. The function of layer 28 is to emit light, while the function of layer 30 is to facilitate hole transport through device 10.

Second buffer layer 32 is made from CuPc with an appropriate thickness as known in the art. In the present embodiment, layer 32 is included to protect the elctroluminescent layer during sputter deposition of additional layers of device 10. However, where sputter deposition is not used it can be desired to omit layer 32.

Third buffer layer 34 is made of lithium flouride (LiF) having a thickness of about five to twenty angstroms (5-20 Å), but in a presently preferred embodiment layer 34 has a thickness of about five angstroms (5 Å). Other suitable materials and thicknesses can be determined by those of skill in the art. The function of this layer is to match the work function of electroluminescent layer 28 and dark layer 36.

In the present embodiment, dark layer 36 is composed of three layers: a partially-reflective layer 36a, an absorptive-transmissive layer 36b and a reflective layer 36c. Layer 36a is made from chromium and is disposed behind buffer layer 34. Layer 36a can have a thickness of between about zero to about one hundred angstroms (0-100 Å). Layer 36a can also have a thickness of between about zero to about forty angstroms (0-40 Å). In a presently preferred embodiment, chromium layer 36a has a thickness of about twelve angstroms (12 Å).

Layer 36b, disposed behind layer 36a is made from chromium silicon monoxide preferably having a thickness of between about two hundred to about eight hundred angstroms (200-800 Å). More preferably, layer 36b can have of thickness of between about four hundred to six hundred angstroms (400-600 Å). In a presently preferred embodiment, layer 36b has thickness of about five hundred angstroms (500 Å).

Layer 36c, disposed behind layer 36b, is also made from chromium preferably having a thickness of between about zero to about fifteen-hundred angstroms (0 A-1500 Å). More preferably, layer 36c has a thickness of about two hundred fifty angstroms (250 Å).

Cathode layer 38 is aluminum (Al) and has a thickness of about fifteen-hundred angstroms (1500 Å), and in the present embodiment it is reflective. Other suitable materials and appropriate thicknesses can be determined by those skilled in the art.

In a variation of the foregoing embodiment, partially-reflective layer 36a is made from aluminum, absorptive-transmissive layer 36b is made from aluminum silicon monoxide, and reflective layer 36c is made from aluminum. Layer 36a can have a thickness of between about zero to about fifty angstroms (0-50 Å). Layer 36a can have a thickness of between about ten to about thirty-five angstroms (10-35 Å). In a presently preferred embodiment, aluminum layer 36a has a thickness of about twenty-five angstroms (25 Å). Layer 36b behind layer 36a is made from aluminum silicon monoxide, preferably, having a thickness of between about two-hundred-and-fifty to about five-hundred angstroms (250-500 Å). More preferably, layer 36b is of thickness of between about two-hundred-and-seventy-five to about four-hundred-and-fifty angstroms (275-450 Å). More preferably, layer 36b is of thickness of between about three-hundred-and-twenty-five to about four-hundred angstroms (325-400 Å). In a presently preferred embodiment, layer 36b has thickness of about three-hundred-and-seventy angstroms (370 Å). Layer 36c, disposed behind layer 36b, is another layer of aluminum, preferably having a thickness between about 1000 Å to about 1500 Å. (When layer 36c is made of aluminum it is contemplated that cathode layer 38 can be eliminated in favour of using layer 36c as the cathode.)

A wavelength of about five-hundred-and-fifty nanometers (550 nm), the centre of the photopic response of the human eye, is the wavelength chosen for the purpose of determining appropriate thicknesses and materials of layers 22 to 38, as the resulting device 10 can have desirable contrast enhancement properties across the visible light spectrum. The appropriate thicknesses and materials are chosen to minimize the reflection of the device at this wavelength. However, it will occur to those skilled in the art that other wavelengths can be selected, as desired, and the appropriate material thickness can be calculated.

When ambient light is incident upon device 10, and passes through anode 22 and electroluminescent layer 28 towards dark layer 36, at least some of the ambient light incident upon dark layer 36 is absorbed thereby and accordingly, ambient light reflected back to the viewer X is reduced.

A top emitting electroluminescent device in accordance with the second embodiment of the invention is indicated generally at 10a in FIG. 1a. Device 10a comprises a substrate 20a (such as glass), a reflecting anode layer 22a, a dark layer 24a composed of three layers 24aa, 24ab and 24ac, a first buffer layer 26a, a hole transport layer 28a, an electroluminescent layer 30a, an electron transport layer 32a, a second buffer layer 34a and electroluminescent transparent cathode 36a as shown in FIG. 1a. Device 10a is connected to a current source 50a via cathode 36a and anode 22a in order to drive a constant current through device 10a.

Electroluminescent transmitting cathode 36a is any transmitting and conducting material suitable for use in a top emitting OLED device. In a presently preferred embodiment, for example, it is contemplated that cathode 36a would include three sub-layers consisting of about one-thousand angstroms of ITO, about one-hundred angstroms of aluminum and about five angstroms of lithium fluoride. Other suitable materials, sub-layers and/or thicknesses can be determined for cathode 36a by those skilled in the art.

Second buffer layer 34a is made from CuPc with an appropriate thickness as known in the art. The function of this layer is to protect the elctroluminescent layer during cathode layer sputter deposition, and could thus be eliminated if other manufacturing techniques are used.

Electron transport layer 32a and electroluminescent layer 30a are made from a single layer of an organic electroluminescent material. In the present embodiment layers 32a and 30a are a single layer of Alq3 preferably having a thickness of about six hundred angstroms (600 Å) although those of skilled in the art will be able to determine other appropriate thicknesses. The function of this single layer is to both facilitate electron transport (layer 32a) and to emit light (layer 30a).

Hole transport layer 28a is made of NPB, preferably having a thickness of about four hundred and fifty angstroms (450 Å). Other suitable materials and appropriate thicknesses can be determined by those skilled in the art. The function of this layer is to facilitate hole transportation through the device.

First buffer layer 26a is made of ITO or ZnO of an appropriate desired thickness. Other suitable materials and thicknesses can be determined by those of skill in the art. The function of this layer is to work-function match dark layer 24a with hole transport layer 28a.

Dark layer 24a is composed of three layers: a partially-reflective layer 24aa, a absorptive-transmissive layer 24ab and a reflective layer 24ac. Layer 24aa is made from chromium and is disposed behind buffer layer 26a. Layer 24aa can have a thickness of between about zero to about one hundred angstroms (0-100 Å). More preferably, layer preferab24aa can have a thickness of between about zero to about forty angstroms (0-40 Å). In a presently preferred embodiment, chromium layer 24aa has a thickness of about twelve angstroms (12 Å).

Layer 24ab, disposed behind, layer 24aa is made from chromium silicon monoxide preferably having a thickness of between about two hundred to about eight hundred angstroms (200-800 Å). More preferably, layer 24ab can have of thickness of between about four hundred to six hundred angstroms (400-600 Å). In a presently preferred embodiment, layer 24ab has thickness of about five hundred angstroms (500 Å).

Layer 24ac, disposed behind layer 24ab, is also made from chromium preferably having a thickness of between about zero to about fifteen-hundred angstroms (0-1500 Å). More preferably, layer 24ac has a thickness of about two hundred fifty angstroms (250 Å).

Anode layer 22a is aluminum (Al) and has a thickness of about fifteen-hundred angstroms (1500 Å), and in the present embodiment it is reflective. Other suitable materials and appropriate thicknesses can be determined by those skilled in the art.

In a variation of the foregoing embodiment, partially reflective layer 24aa is made from aluminum, absorptive-transmissive layer 24ab is made from aluminum silicon monoxide, and reflective layer 24ac is made from aluminum. Layer 24aa can have a thickness of between about zero to about fifty angstroms (0-50 Å). More preferably, layer 24aa has a thickness of between about ten to about thirty-five angstroms (10-35 Å). Most preferably, aluminum layer 24aa has a thickness of about twenty-five angstroms (25 Å). Layer 24ab behind layer 24aa is made from aluminum silicon monoxide, preferably, having a thickness of between about two-hundred-and-fifty to about five-hundred angstroms (250-500 Å). More preferably, layer 24ab is of thickness of between about two-hundred-and-seventy-five to about four-hundred-and-fifty angstroms (275-450 Å). More preferably, layer 24ab is of thickness of between about three-hundred-and-twenty-five to about four-hundred angstroms (325-400 Å). In a presently preferred embodiment, layer 24ab has thickness of about three-hundred-and-seventy angstroms (370 Å). Layer 24ac, disposed behind layer 24ab, is another layer of aluminum, preferably having a thickness between about 1000 Å to about 1500 Å. In this variation, anode layer 22a can eliminated as layer 24ac can itself act as the anode.

As known to those skilled in the art, work function matching buffer layer 26a is not necessary if the dark layer is made of high work function material.

Those of skilled in the art will now appreciate that the manufacture and operation of device 10a is substantially identical to, with appropriate modifications, the manufacture and operation of device 10.

While only specific combinations of the various features and components of the present invention have been discussed herein, it will be apparent to those of skill in the art that desired sub-sets of the disclosed features and components and/or alternative combinations and variations of these features and components can be utilized, as desired. For example, the various buffer layers described herein can be omitted, though with commensurate potential for degradation in the operation of the device.

Other variations will now occur to those of skill in the art, for example, substrate 20 could made from a flexible material, such as Mylar™. Where such flexible materials are used, it is to be understood that appropriate materials will be chosen for the other layers in the device—for example, PEDOT from AGFA can be used for the anode of the device.

Furthermore, it is contemplated that other materials can be used for emitting layer 28 other than Alq3. For example, other types of small-molecule materials, other than Alq3 can be used. As an additional example, another type of emitting material could be a polymer-based emitting material, such as Polyphenylene vinylene (PPV). In such cases it is further contemplated that other materials and thicknesses would be used for the other layers of device 10 to correspond with the features of PPV.

It is contemplated that certain layers in device 10 that are associated with the light emitting functionality of device 10, (i.e. second buffer layer 32, which can be used to protect emitting layer 28 during sputtering deposition of other layers of device 10) can be eliminated and still provide a functional device. In general, it is to be understood that the layers of device 10 directed to light emission can be varied and/or be composed of a different light emitting stack. By the same token, the structure of dark layer 36 can be varied to correspond with the particular stack chosen to effect light emission.

Furthermore, it is to be understood that emitting layer 28 can be made doped with different materials, to provide different emitted colours from layer 28.

In general, a matrix or (other pattern) of a plurality of devices 10 (or variations thereof) can be built into a display, whether colour or monochromatic.

The devices taught herein can be fabricated using techniques known in the art respective to the particular stack of layers and materials that are chosen. For example, vacuum-deposited, thermal evaporation or e-beam can be used for non-polymer materials. Where the device is based on polymer materials such as PPV then spin-coating or inkjet printing can be appropriate for the organic materials.

Those of skilled in the art will appreciate the fact that other mixtures of metals and ceramics, generally referred to as Cermets, with proper work function matching could also be used to fabricate dark layers 36 and 24 in order to achieve the desired reflection response. Examples of metals are Al, Cu, Au, Mo, Ni, Pi, Rh, Ag, W, Cr, Co, Fe, Ge, Hf, Nb, Pd, Re, V, Si, Se, Ta, Y, and Zr. Examples of oxides are Al₂O₃, SiO₂, ZrO₂, HfO₂, Sc₂O₃, TiO₂, ITO, La₂O₃, MgO, Ta₂O₅, ThO₂, Y₂O₃, CeO₂, Sb₂O₃, Bi₂O₃, Nd₂O₃, Pr₆O₁₁, SiO, ZnO, and GdO₃.

Furthermore, it will now be understood by those of skill in the art that the dark layer taught herein can be modified to work with inorganic electroluminescent structures.

All documents external to this patent application that are referred to herein are hereby incorporated by reference.

We claim:

1. An electroluminescent device for displaying an image to a viewer in front of said device, comprising:
A front electrode layer, being said front and being substantially transparent to electroluminescent light;
an organic electroluminescent layer disposed behind said front electrode layer;
a dark layer, comprising a partially reflective layer, an absorptive-transmissive layer and a reflective layer, disposed behind said electroluminescent layer;
a rear electrode layer disposed behind said dark layer.

2. The device of claim 1 wherein said front electrode is an anode and said rear electrode is an cathode.

3. The device of claim 1 wherein said front electrode is a cathode and said rear electrode is an anode.

4. The device according to claim 2 wherein said front electrode layer is made from ITO of a thickness of about 1200 Å.

5. The device according to claim 2 and wherein a first buffer layer is disposed behind said anode layer and is made from CuPc of a thickness of about 250 Å.

6. The device according to claim 2 wherein a hole transport layer is disposed behind said first buffer layer and is made from NPB of a thickness of about 450 Å.

7. The device according to claims 2 wherein said electroluminescent layer is made from tris(8-quinolinolato aluminum) (Alq3) having a thickness of about 600 Å.

8. The device according to claims 2 wherein an electron transport layer is disposed behind said electroluminescent layer.

9. The device according to claims 2 wherein a protective buffer layer is disposed behind said electroluminescent layer.

10. The device according to claims 2 wherein a second buffer layer is disposed behind said electroluminescent layer and is made from lithium fluoride (LiF) of a thickness between about 5 Å and 20 Å.

11. The device according to claims 10 wherein a second buffer layer is disposed behind said electroluminescent layer and is made from lithium fluoride (LiF) of a thickness of about 5 Å.

12. The device according to claims 2 wherein said rear electrode layer is made from aluminum (Al) of a thickness about 1500 Å.

13. An electroluminescent device for displaying an image to a viewer in front of said device, comprising:
a front anode layer made from indium tin oxide (ITO) having a thickness of about 1200 Å, being said front and being substantially transparent to electoluminescent light;
a first buffer layer, disposed behind said anode layer, made from CuPc having a thickness of about 250 Å;
a hole transport layer, disposed behind said first buffer layer, made from NPB having a thickness of about 450 Å;
an organic electroluminescent layer, disposed behind said hole transport layer, made from tris(8-quinolinolato aluminum) (Alq3) having a thickness of about 600 Å;
an electron transport layer disposed behind said electroluminescent layer;
a second buffer layer disposed behind said electron transport layer;
a third buffer layer, disposed behind said electroluminescent layer, made from lithium fluoride (LiF) having a thickness of about 5 Å;
a dark layer, comprising a partially reflective layer, an absorptive-transmissive layer and a reflecting layer, disposed behind said second buffer layer;
a rear cathode layer, disposed behind said dark layer, made from aluminum (Al) having a thickness of about 1500 Å.

14. The device according to claim 13 wherein said partially reflective layer is made from chromium.

15. The device according to claim 14 wherein said partially reflective chromium layer has a thickness of between about zero to about 100 Å.

16. The device according to claim 15 wherein said partially reflective chromium layer has a thickness of between about zero to about 40 Å.

17. The device according to claim 16 wherein said partially reflective chromium layer has a thickness of about 12 Å.

18. The device according to claim 13 wherein said absorptive-transmissivelayer is made from chromium silicon monoxide.

19. The device according to claim 18 wherein said absorptive-transmissivechromium silicon monoxide layer has a thickness of between about 200 Å to about 800 Å.

20. The device according to claim 19 wherein said absorptive-transmissivechromium silicon monoxide layer has a thickness of between about 400 Å to about 600 Å.

21. The device according to claim 20 wherein said absorptive-transmissivechromium silicon monoxide layer has a thickness of 500 Å.

22. The device according to claim 13 wherein said reflecting layer is made from chromium.

23. The device according to claim 22 wherein said reflecting chromium layer has a thickness between about zero to about 1500 Å.

24. The device according to claim 23 wherein said reflecting chromium layer has a thickness of about 250 Å.

25. The device according to claim 13 wherein said partially reflective layer is made from aluminum.

26. The device according to claim 25 wherein said partially reflective aluminum layer has a thickness of between about zero to about 50 Å.

27. The device according to claim 26 wherein said partially reflective aluminum layer has a thickness of between about 10 Å to about 35 Å.

28. The device according to claim 27 wherein said partially reflective aluminum layer has a thickness of about 25 Å.

29. The device according to claims 13 wherein said absorptive-transmissivelayer is made from aluminum silicon monoxide.

30. The device according to claim 29 wherein said absorptive-transmissivealuminum silicon monoxide layer has a thickness of between about 250 Å to about 500 Å.

31. The device according to claim 30 wherein said absorptive-transmissivealuminum silicon monoxide layer has a thickness of between about 275 Å to about 450 Å.

32. The device according to claim 31 wherein said absorptive-transmissivealuminum silicon monoxide layer has a thickness of between about 325 Å to about 400 Å.

33. The device according to claim 32 wherein said absorptive-transmissive-aluminum silicon monoxide layer has a thickness of about 370 Å.

34. The device according to claim 13 wherein said reflecting layer is made from aluminum having a thickness between about 1000 Å to about 1500 Å.

35. The device according to claim 1 wherein said device is deposited on a substrate that is flexible.

36. An electroluminescent device for displaying an image to a viewer in front of said device, comprising:
A front electrode layer, being said front and being substantially transparent to electoluminescent light;
an organic electroluminescent layer disposed behind said front electrode layer;
a dark layer, comprising a partially reflective layer, a partially absorptive-transmissive layer and a reflective layer, disposed behind said electroluminescent layer; and,
said reflective layer being operable to function as a rear electrode layer.
